(19) United States
(12) Patent Application Publication
(10) Pub. No.: US 2026/0177459 A1
(43) Pub. Date: Jun. 25, 2026

(54) DETECTING TRACTOR AND TRAILER TIRE FAULTS WITH AUDIO SIGNAL ANOMALIES

(71) Applicant: Torc Robotics, Inc., Blacksburg, VA (US)

(72) Inventors: Xholjon Dede, Esslingen am Neckar (DE); Sebastian Dingler, Stuttgart (DE); Matthew Swanson, Blacksburg, VA (US); Paul Birth, Esslingen (DE); Christopher Harrison, Austin, TX (US)

(21) Appl. No.: 18/991,110

(22) Filed: Dec. 20, 2024

(51) Int. Cl. G01M 17/02; B60W 30/14; B60W 50/02; B60W 50/14; B60W 60/00; H04R 1/40; H04R 3/00

(52) U.S. Cl. CPC G01M 17/025; B60W 30/143; B60W 50/0205; B60W 50/0225; B60W 50/14; B60W 60/0015; H04R 1/406; H04R 3/005; B60W 2420/54; H04R 2499/13

(57) ABSTRACT

An AV includes at least one memory and at least one processor coupled to the memory, configured to execute the stored instructions to perform the following: receive inputs from one or more acoustic sensors positioned at one or more locations on the AV, with the sensors capturing audio signals associated with AV operation in its surrounding environment. The AV processes these inputs to identify audio signals generated by specific components of the AV. The AV processes the inputs to isolate distinct sound patterns to determine if they are indicative of an anomaly associated with a component failure. The AV analyzes these audio signals to detect periodic sound patterns related to tire rotation, assessing the frequency and amplitude of these patterns to identify a specific tire exhibiting an anomaly. In response to detecting a tire anomaly, the AV initiates a corrective action by the AV to address the detected issue.

### FIELD OF THE TECHNOLOGY

The field of the disclosure pertains to systems and methods for detecting anomalies in vehicle operation, specifically targeting unusual driving behavior caused by tire blowouts in vehicles.

### BACKGROUND OF THE TECHNOLOGY

Autonomous vehicles (AVs) rely on several core technologies, including perception, localization, behavior planning, and control systems. Perception technologies enable an AV to sense its environment, process the data, and classify objects or groups of objects, such as pedestrians, vehicles, and road debris. Localization technologies determine the vehicle's position within its environment by correlating features detected by perception technologies with known features on a digital map. These localization methods often incorporate data from inertial navigation systems (INS) to maintain high accuracy. Behavior planning technologies use data from perception and localization systems to determine optimal routes and maneuvers, allowing the AV to navigate efficiently toward its planned destination. Finally, control systems translate planned behaviors into physical actions through dynamic mechanical components, such as steering, braking, and acceleration, to execute the planned trajectory.

Control technologies in AVs are also responsible for detecting operational anomalies, which may indicate faults, malfunctions, or unintended contact with objects along the vehicle's path. These systems continuously monitor driving behaviors, identifying deviations from expected operation patterns that could signify underlying issues requiring immediate action. For instance, perception and localization must accurately assess deviations resulting from tire blowouts or sensor malfunctions, ensuring that the AV responds appropriately to maintain stability and safety. When anomalies occur, the system must classify the type of fault-whether from mechanical failures, such as a tire blowout, sensor errors, or obstacles in the environment. This accurate classification allows the AV's control system to initiate specific corrective actions, such as adjusting speed, modifying its route, or performing an emergency stop. By discerning the nature of incidents and applying suitable countermeasures, these control systems are crucial for maintaining the operational reliability and safety of AVs, particularly under unexpected conditions.

This section is intended to introduce the reader to various aspects of the technology that may be related to the present disclosure. The description provides background information to facilitate a better understanding of the aspects of the present disclosure and should not be considered as admissions of prior art.

### SUMMARY OF THE TECHNOLOGY

In one aspect, the disclosed technology described herein relate to a computing system for detecting anomalies of an autonomous vehicle (AV) while navigating a route, the system including: at least one memory configured to store machine executable instructions; and at least one processor coupled to the at least one memory and configured to execute the machine executable instructions to: receive a plurality of inputs from one or more acoustic sensors positioned in one or more locations of the AV, wherein the acoustic sensors are configured to capture audio signals associated with operation of the AV from an environment surrounding the AV; process the plurality of inputs to identify one or more audio signals from the one or more acoustic sensors that are generated by at least one component of the AV; in response to identifying the one or more audio signals, processing the one or more audio signals to isolate one or more sound patterns; to identify whether the sound patterns are associated with an anomaly that represents a failure of the at least one component of the AV; process the one or more sound patterns to identify periodic sound patterns associated with tire rotation, wherein the processing includes a determination of a frequency and an amplitude of the periodic sound patterns to detect a specific tire of the AV exhibiting the anomaly; and initiate a corrective action by the AV in response to detecting a tire anomaly.

In another aspect, the disclosed technology described herein relate to an autonomous vehicle (AV), including: one or more tires; at least one acoustic sensor configured to collect one or more audio signals from an environment surrounding the AV; a memory configured to store machine executable instructions; and at least one processor configured to execute the stored executable instructions to: receive a plurality of inputs from one or more acoustic sensors positioned in one or more locations of the AV, wherein the acoustic sensors are configured to capture audio signals associated with operation of the AV from an environment surrounding the AV; process the plurality of inputs to identify one or more audio signals from the one or more acoustic sensors that are generated by at least one component of the AV; in response to identifying the one or more audio signals, processing the one or more audio signals to isolate one or more sound patterns to identify whether the sound patterns are associated with an anomaly that represents a failure of the at least one component of the AV; process the one or more sound patterns to identify periodic sound patterns associated with tire rotation, wherein the processing includes a determination of a frequency and an amplitude of the periodic sound patterns to detect a specific tire of the AV exhibiting the anomaly; and initiate a corrective action by the AV in response to detecting a tire anomaly.

In yet another aspect, the disclosed technology described herein relate to a method including: receiving a plurality of inputs from one or more acoustic sensors positioned in one or more locations of an autonomous vehicle (AV), wherein the acoustic sensors are configured to capture audio signals associated with operation of the AV from an environment surrounding the AV; processing the plurality of inputs to identify one or more audio signals from the one or more acoustic sensors that are generated by at least one component of the AV; in response to identifying the one or more audio signals, processing the one or more audio signals to isolate one or more sound patterns; to identify whether the sound patterns are associated with an anomaly that represents a failure of the at least one component of the AV; processing the one or more sound patterns to identify periodic sound patterns associated with tire rotation, wherein the processing includes a determination of a frequency and an amplitude of the periodic sound patterns to detect a specific tire of the AV exhibiting the anomaly; and initiating a corrective action by the AV in response to detecting a tire anomaly.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck according to some aspects of the present disclosure;

FIG. 2 is a block diagram of the autonomous truck shown in FIG. 1, according to some aspects of the present disclosure;

FIG. 3 illustrates an aspect of the subject matter in accordance with one embodiment;

FIG. 4 illustrates an example tire detected as experiencing a failure according to some aspects of the present disclosure;

FIG. 5A illustrates an example audio signal plot of signals received from one or more acoustic sensors according to some aspects of the present disclosure;

FIG. 5B illustrates an example normal environment plot filtered from the audio signal plot according to some aspects of the present disclosure;

FIG. 5C illustrates an example anomaly detection plot filtered from the audio signal plot according to some aspects of the present disclosure;

FIG. 6 is a flow diagram of an example embodiment method for detecting anomalies of an autonomous vehicle (AV) while navigating a route according to some aspects of the present disclosure; and

FIG. 7 is a block diagram of an example computing system according to some aspects of the present technology.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Anomaly Detection: Anomaly detection is the process of identifying deviations from normal operational behavior within the autonomous vehicle's systems or driving environment. For autonomous vehicles (AVs), precise anomaly detection is essential to ensure safe operation and rapid response to unexpected conditions. This process involves continuously analyzing data from multiple sensors—such as acoustic sensors, inertial measurement units (IMUs), and vision systems—to detect irregular patterns that may indicate faults, malfunctions, or external obstacles. By identifying these deviations in real-time, the vehicle's control system can determine the appropriate response, such as adjusting speed, altering the vehicle's trajectory, or initiating a controlled stop.

Autonomous trucks and trailers encounter significant challenges in detecting mechanical failures, particularly tire blowouts, during operation without human intervention. Unlike conventional trucks, where a driver detects a blown tire through audible cues or changes in vehicle dynamics, autonomous systems lack this sensory feedback. This challenge is especially pronounced in older trailer models that do not utilize Tire Pressure Monitoring Systems (TPMS) or Anti-lock Braking System (ABS) modules, making the detection of such issues difficult and unreliable. Without timely recognition of a blown tire, autonomous vehicles face increased risks, as blowouts can lead to erratic steering behavior, instability, and potential loss of control, potentially compromising safety for the vehicle and surrounding traffic.

Traditional methods of fault detection in autonomous trucks rely heavily on integrated sensor systems, but these systems are often limited in their ability to identify and respond to mechanical anomalies on older trailers. A blown tire that goes undetected can result in debris on the road, posing hazards to other drivers, and increase the likelihood of secondary accidents. The lack of precise, real-time anomaly detection in autonomous trucks underscores the need for robust detection technologies capable of identifying tire blowouts early. Such systems would enable autonomous trucks to initiate corrective actions—such as reducing speed, maneuvering to the shoulder, or exiting the roadway—ensuring safer operation and reliable autonomous performance across varied driving conditions.

The disclosed systems and methods comprise an advanced detection system that integrates acoustic sensors positioned on the tractor of an autonomous truck-trailer configuration, enabling effective monitoring of tire integrity. These sensors, strategically oriented toward the trailer's tires, are configured to capture and analyze audio signals, specifically targeting sounds indicative of tire blowouts or other rotational anomalies. Each sensor is designed to detect periodic acoustic patterns generated as a damaged tire completes each rotation, allowing for real-time identification of tire faults based on distinct sound signatures. The system's embedded software control processes these audio inputs, isolating irregular patterns in sound frequency and amplitude, which are cross-referenced against the known rotational period of each wheel. By correlating the detected audio anomalies with tire rotation metrics, the system can pinpoint the exact wheel exhibiting the issue, or the location of other anomalies being experienced by the vehicle ensuring precise fault localization.

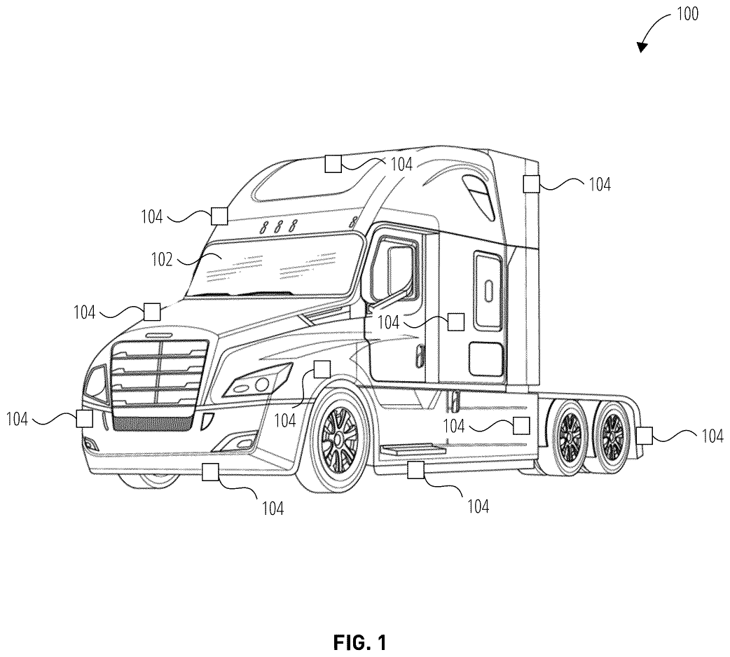

Various embodiments in the present disclosure are described with reference to FIGS. 1-4 below. Further, even though the embodiments are described for perception technologies used in autonomous vehicles, the embodiments described herein do not limit their scope to autonomous vehicles only and may be embodied in non-autonomous vehicles or semi-autonomous vehicles as well.

FIG. 1 illustrates an autonomous vehicle 100, such as a truck that may be conventionally connected to a single or tandem trailer to transport the trailer (not shown) to a desired location. The autonomous vehicle 100 includes a cabin 102 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 102.

The autonomous vehicle 100 may be an autonomous vehicle, in which case the autonomous vehicle 100 may omit the steering wheel and the steering column to steer the autonomous vehicle 100. Rather, the autonomous vehicle 100 may be operated by an autonomy computing system (not shown) of the autonomous vehicle 100 based on data collected by a sensor network (not shown in FIG. 1) including one or more sensors.

In an example, the one or more sensors can include one or more acoustic sensors 104. Acoustic sensors 104 are positioned asymmetrically around the exterior of the autonomous vehicle 100. This asymmetric placement is configured to increase the accuracy of detecting anomalies while reducing blind spots and allowing better differentiation of sound origins. For instance, sounds produced by the left-side tires can be more easily distinguished from those on the right side. As a result, the asymmetrical placement of the acoustic sensors 104 assist with isolation of the specific component responsible for generating abnormal noises.

Acoustic sensors 104 are configured to obtain a plurality of audio signals from the environment surrounding the vehicle as it navigates along a route. The audio signals gathered by the acoustic sensors 104 can capture both normal environmental sounds, such as weather-related noises (e.g., rain, snow, wind), road surface interactions, and ambient traffic sounds, as well as detect anomalies that deviate from typical environmental sounds.

The detected anomalies may include indications of malfunctions in one or more components of the autonomous vehicle 100. Such components can include, for example, the suspension system, tires, brake assemblies, wheel bearings, engine components, or transmission system.

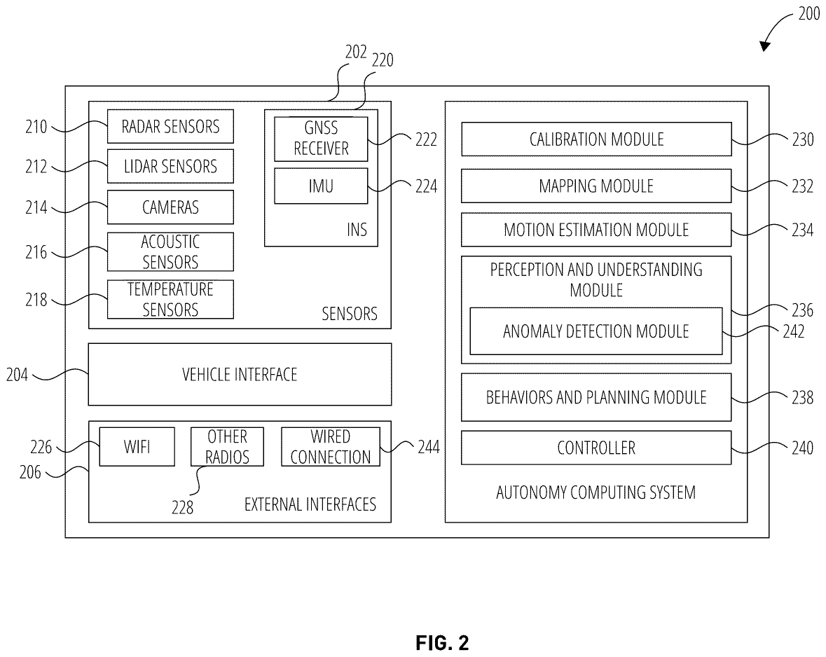

FIG. 2 is a block diagram of autonomous vehicle 100 shown in FIG. 1. In the example embodiment, autonomous vehicle 100 includes autonomy computing system 200, sensors 202, vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and the effect these conditions could have on the performance and navigation of the autonomous vehicle 100. As described in further detail below, these signals may be utilized by autonomy computing system 200 for the detection anomalies in vehicle operation, specifically targeting unusual driving behavior caused by tire blowouts in vehicles.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In some embodiments, sensors 202, such as the acoustic sensors 216, are employed to detect anomalies in vehicle operation by capturing and analyzing audio signals from a plurality of microphones strategically positioned around the vehicle. These acoustic sensors 216 are designed to detect specific sound patterns that could indicate faults, such as tire blowouts, which are often characterized by a distinct, periodic noise occurring with each full rotation of the affected tire. By utilizing, for example, multiple microphones, the system can capture a more comprehensive audio profile, isolating the specific sounds associated with a blowout from general road noises, like wind or typical engine sounds.

The autonomy computing system 200 receives and processes this audio data by filtering out normal ambient sounds and focusing on detecting high peaks within the audio signal that repeat periodically. By measuring the interval, or period, of these peaks, the system can compare them with the expected rotational period of a tire under normal operating conditions. If the detected period aligns with the timing associated with a full tire rotation, the system can classify this as an anomaly and issue an alert or initiate corrective actions.

In the example embodiment, autonomy computing system 200 can employ vehicle interface 204 to send commands or data to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and the anomaly detection module 242.

The anomaly detection module 242, for example, may be embodied within another module, such as perception and understanding module 236, or separately. Alternatively, the anomaly detection module 242 may be embodied within the behaviors and planning module 238. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The anomaly detection module 242 is configured to detect one or more failures of vehicle components by receiving audio signals from a plurality of acoustic sensors positioned on the vehicle. The anomaly detection module processes audio signals by filtering out typical environmental noises, such as wind, rain, engine hum, and tire noise on various surfaces. For example, while driving on a highway, the acoustic sensors capture the consistent hum produced by wind resistance and the rhythmic noise of tires rolling on asphalt. By establishing these sounds as part of the baseline normal operation, the anomaly detection module can more effectively distinguish unexpected or irregular noises, such as a popping sound from a damaged tire, thus isolating the true anomalies that may indicate a failure. The module is further configured to filter out normal environmental noises, such as wind, rain, and road noise, to isolate sound patterns specifically indicative of a failure, ensuring accurate detection and minimizing false positives.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

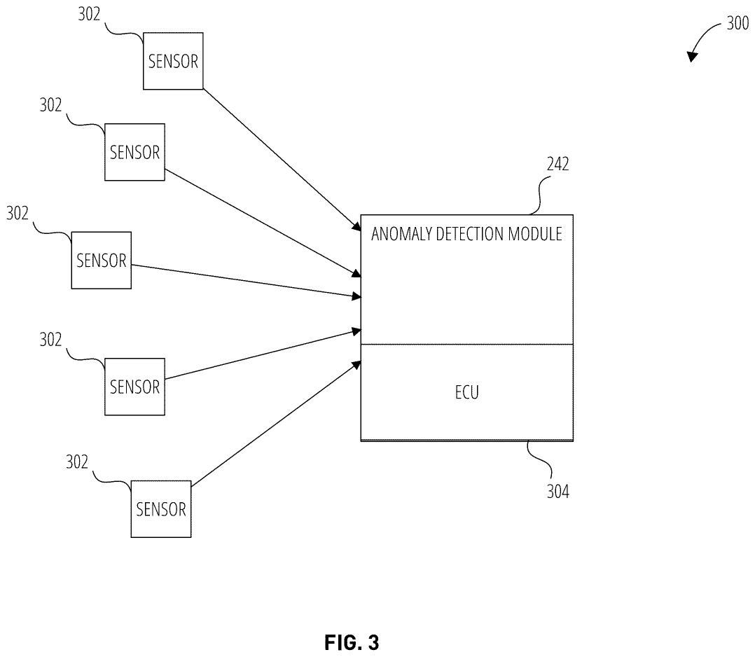

FIG. 3 illustrates an example system 300 for processing audio signals captured by the one or more acoustic sensors 302 according to some aspects of the disclosure.

By analyzing sound patterns that align with detected anomalies, the system can differentiate between normal operational conditions and potential failure states, enabling timely corrective actions to ensure the safety and reliability of the autonomous vehicle 100. FIG. 3 illustrates a system 300 designed to detect tire faults and other component anomalies in an autonomous vehicle (AV), such as the autonomous vehicle 100 depicted in FIG. 1 and FIG. 2, by analyzing audio signal anomalies captured from the surrounding environment.

The system 300 includes a plurality of acoustic sensors 302, such as microphones, strategically positioned asymmetrically around the AV 100, as shown in FIG. 1, to capture a range of audio signals from the surrounding environment. This asymmetric placement ensures optimal coverage to detect a variety of sounds. The acoustic sensors 302 are configured to capture both normal environmental sounds and anomalies indicative of potential failures.

Normal sounds include ambient environmental noises such as wind, rain, or the hum of tires on a smooth road, as well as operational sounds from the vehicle itself that are consistent with proper functioning. In contrast, anomalies refer to unusual noises that deviate from these normal patterns, such as irregular clunking, grinding, or periodic sounds that may indicate failures in one or more components of the AV. These components can include mechanical parts such as the suspension system, brake assemblies, engine components, or tires, including tire blowouts or embedded objects causing irregular noise patterns.

The audio signals captured by the acoustic sensors 302 are transmitted to the anomaly detection module via the ECU 304 for processing. The anomaly detection module processes the signals to determine whether they indicate an anomaly. This processing involves filtering out normal environmental noises while isolating sound patterns that may align with potential failures. If an anomaly is detected, the system identifies the location of failure associated with the anomaly, assesses its severity, and identifies the affected component. The anomaly detection module then determines appropriate remedial actions, such as reducing vehicle speed, directing the AV to a safe location, or alerting maintenance personnel, ensuring operational safety and reliability.

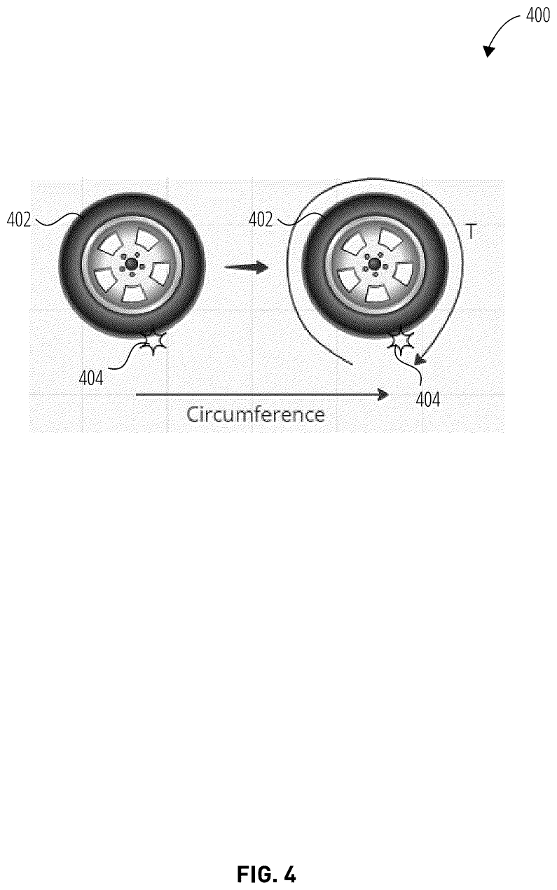

FIG. 4 illustrates an example of detecting tire faults in an AV, such as autonomous vehicle 100 shown in FIGS. 1 and 2, by analyzing audio signal anomalies captured from the surrounding environment according to some aspects of the present disclosure.

Under normal operating conditions, tire 402 generates audio signals as it contacts the roadway, including surfaces such as pavement or asphalt, during varying speeds and accelerations. These sounds, captured by one or more acoustic sensors positioned around the AV, are indicative of normal operation and include characteristics influenced by environmental conditions such as rain, snow, and ice. These normal tire sounds are processed by the anomaly detection module 242 and are identified as standard operating noise, which does not trigger an anomaly determination.

An anomaly, such as a blowout or structural failure of tire 402, is detected based on a comparison of periodic peaks in the captured audio signal with the expected tire rotation period. The anomaly detection module 242 calculates this expected period using the known circumference of tire 402 (U) and the vehicle's driving speed (v) according to the formula:

$$T = \frac{U}{v} .$$

To account for uncertainties and variations in rotational measurements, the anomaly detection module 242 defines the expected period as an interval [T−e, T+e], where (e) represents an error parameter reflecting tolerances in the calculation. Periodic peaks in the audio signals that align with this interval are further analyzed to determine their amplitude and frequency characteristics. If the periodic peaks exceed a predefined threshold and correspond to this interval, the anomaly detection module 242 concludes that a failure, such as a blowout, is present in tire 402.

In an example, tire 402 experiences a potential failure while the autonomous vehicle (AV) is navigating along a route. One or more acoustic sensors positioned around the AV capture audio signals generated as tire 402 rotates and contacts the roadway. These audio signals are transmitted to the anomaly detection module 242, where they are analyzed to determine whether any anomalies are present.

During the analysis, the anomaly detection module 242 processes the received audio signals to compare their characteristics against the expected period T, which represents the time it takes for tire 402 to complete a full rotation. As the signals are processed, the anomaly detection module 242 identifies whether any audio signals have a decibel amplitude above a predefined threshold during the period T.

If the decibel amplitude exceeds the threshold at any point during rotation of tire 402, this is flagged as an indication of a potential failure. For instance, a sharp increase in amplitude may occur periodically as the damaged portion of tire 402 contacts the road surface. This increase in amplitude suggests that a component failure 404, such as a blowout, puncture, or structural defect, is taking place.

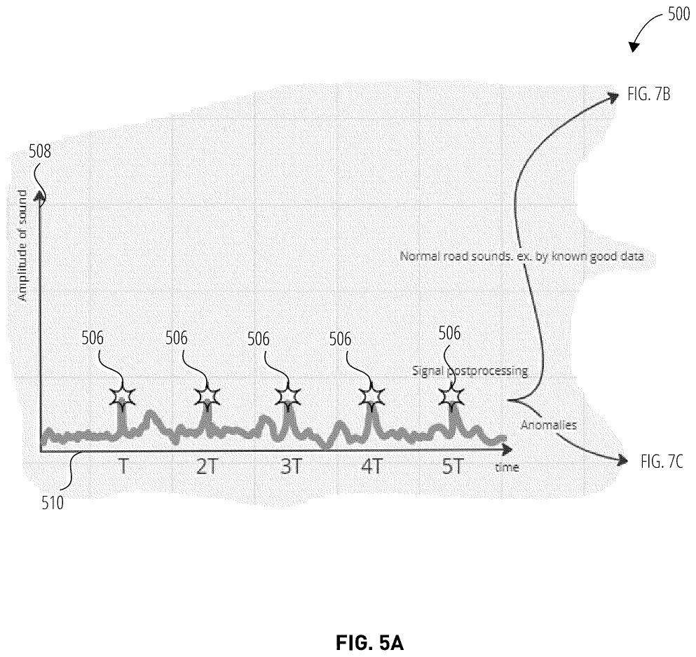

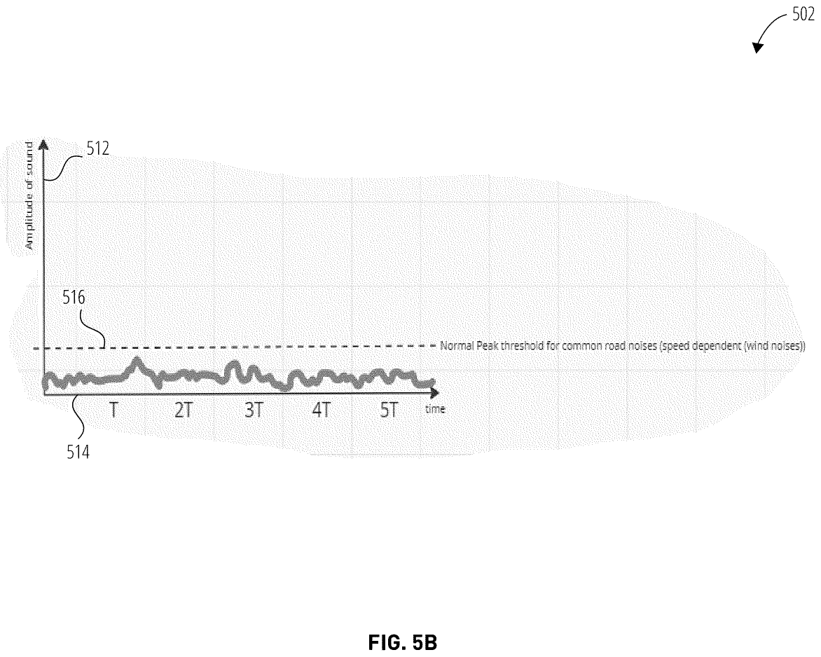

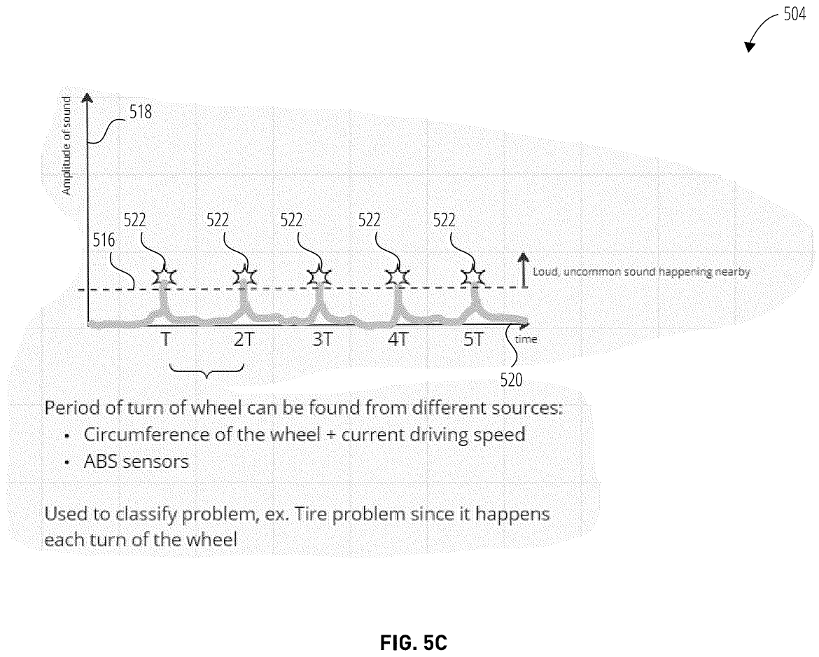

FIG. 5A illustrates an example audio signal plot of signals received from one or more acoustic sensors according to some aspects of the present disclosure.

The anomaly detection module 242, shown in FIG. 2, identifies tire faults, such as blowouts, even under varying weather conditions like rain, snow, or ice. The anomaly detection module 242 differentiates between typical environmental sounds and anomalies by establishing baseline audio signatures captured by the one or more acoustic sensors for each condition. These audio signatures, measured in decibels, are plotted on audio signal plot 500. For instance, during rain, the acoustic sensors capture the consistent patter of raindrops and the increased tire noise from wet surfaces. If a tire experiences a failure, such as a blowout, the system detects a distinct change in amplitude and frequency that does not match the baseline audio signature of normal operation under those conditions.

The anomaly detection module 242 continuously processes audio signals to identify patterns indicative of potential component failures. For instance, in the event of a tire blowout or structural failure, as illustrated in FIG. 4, the acoustic sensors capture periodic noise spikes generated each time the damaged portion of tire 308 completes a rotation. These spikes are caused by structural anomalies or embedded objects and are reflected as distinct increases in amplitude at specific intervals corresponding to the rotational period.

These periodic spikes are represented on an audio signal plot 500, where the y-axis represents the amplitude of sound 508, and the x-axis represents time 510. As shown in plot 500, the anomaly detection module 242 identifies amplitude spikes 506 that occur at regular intervals corresponding to the tire's rotational period, such as (T, 2T, 3T, 4T) and (5T). Each spike indicates a deviation from normal sound levels, consistent with the recurring contact of a damaged portion of the tire with the road surface.

The data in signal plot 500 can be further processed to filter out normal road sounds, allowing for further isolation of anomalies enabling the anomaly detection module to focus on relevant signals, as will be discussed in greater detail with reference to FIG. 5B and FIG. 5C.

FIG. 5B illustrates an example normal environment plot filtered from the audio signal plot according to some aspects of the present disclosure.

FIG. 5B illustrates a normal environment plot 502, representing the amplitude of sound 512 on the y-axis over a period of time 514 on the x-axis. This plot provides a baseline for identifying normal environmental noises encountered by the autonomous vehicle (AV) while navigating its route. These normal sounds, captured by acoustic sensors, include typical environmental noises such as wind, rain, tire interaction with the road surface, and other ambient conditions associated with the AV's surroundings.

As shown in FIG. 5B, anomaly detection module 242, as shown in FIG. 2, filters these normal sounds to distinguish them from anomalies, enabling the identification of environmental noise patterns specific to the road or route the AV is traversing. Over time periods (T, 2T, 3T, 4T) and (5T), the anomaly detection module 242 sets a threshold 516 based on the amplitudes of the normal environmental noises detected. This threshold 516 represents the maximum decibel level that normal environmental noise is expected to reach under the current driving conditions.

The threshold 516 can be dynamically adjustable to account for changes in environmental conditions, such as transitioning from smooth pavement to rough asphalt, driving in heavy rain versus light drizzle, or encountering wind noise variations in open versus urban environments. For example, the threshold can increase when the AV encounters higher ambient noise levels due to weather conditions or road irregularities and decrease when the vehicle enters quieter zones, such as tunnels or residential areas.

In instances where the threshold is exceeded, the anomaly detection module 242 can determine that an anomaly is taking place, which may indicate failures or malfunctions, which will be further described in FIG. 5C.

FIG. 5C illustrates an example anomaly detection plot filtered from the audio signal plot according to some aspects of the present disclosure.

FIG. 5C includes an anomaly detection plot 504, representing the amplitude of sound 518 on the y-axis over a period of time 520 on the x-axis. This plot demonstrates the processing of audio signals to identify anomalies exceeding a predefined threshold, which was established based on normal environmental noise in FIG. 5B.

As shown in FIG. 5C, the anomalies 522 originally detected in FIG. 5A is now refined after filtering out normal environmental sounds in FIG. 5B. Each anomaly 522 exceeds threshold 516, indicating that the sound levels surpass the maximum amplitude expected for normal environmental noise. These elevated sound levels are processed by the anomaly detection module 242 to determine the likelihood of a failure with one or more components of the AV.

The anomaly detection module 242 further processes the filtered signals to identify periodic spikes in amplitude corresponding to the rotational period of tire 402, as shown in FIG. 4. By comparing the periodicity of these spikes with the calculated rotation period based on the tire's circumference and vehicle speed, the module confirms the presence of an anomaly. As depicted in FIG. 5C, the periodic spikes align with the calculated rotational period, confirming that the anomalies originate from tire 402.

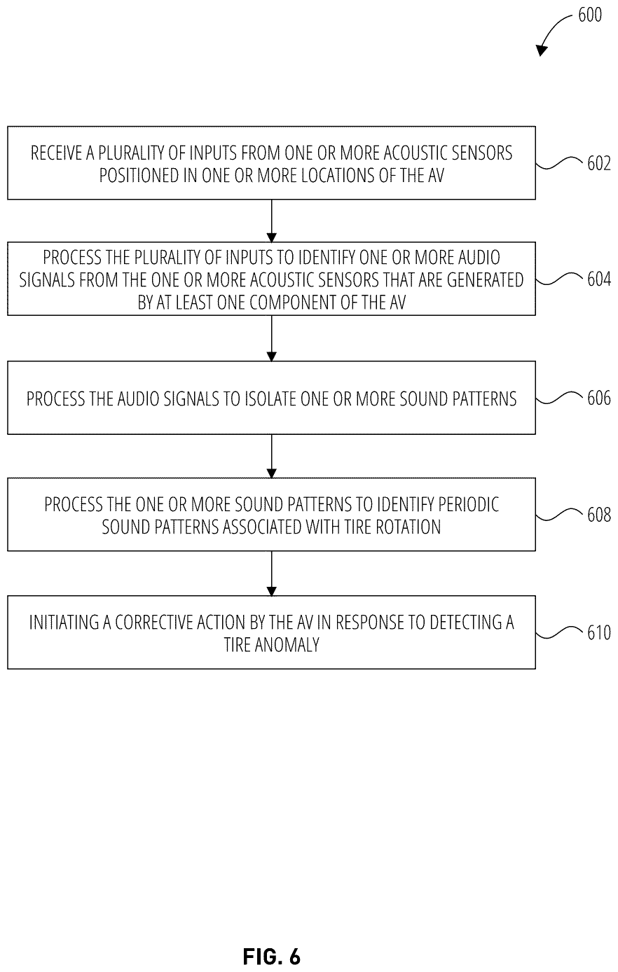

FIG. 6 is a flow diagram of an example embodiment method 600 for detecting anomalies of an AV, such as autonomous vehicle 100 shown in FIGS. 1 and 2, while navigating a route according to some aspects of the present disclosure. Although the example method 600 depicts a particular sequence of operations, the sequence may be altered without departing from the scope of the present disclosure. For example, some of the operations depicted may be performed in parallel or in a different sequence that does not materially affect the function of method 600. In other examples, different components of an example device or system that implements method 600 may perform functions at substantially the same time or in a specific sequence.

According to some examples, method 600 includes receiving a plurality of inputs from one or more acoustic sensors positioned in one or more locations of an autonomous vehicle at block 602. For example, anomaly detection module 242, as shown in FIG. 2, may receive multiple inputs from one or more acoustic sensors positioned at various locations on an autonomous vehicle (AV). These acoustic sensors are designed to capture audio signals related to the operation of the AV from the surrounding environment. The acoustic sensors are strategically positioned asymmetrically on the external surface of the AV. One or more processors within the AV are configured to process the audio signals, utilizing the differences in sound patterns detected by the asymmetrically positioned acoustic sensors to triangulate the location of the anomaly. The identified location corresponds to a failed component of the AV, enabling precise detection and localization of the anomaly.

Method 600 includes processing 404 the plurality of inputs to identify one or more audio signals from the one or more acoustic sensors that are generated by at least one component of the AV. For example, anomaly detection module 242, as illustrated in FIG. 2, may process the plurality of inputs to identify one or more audio signals captured by the one or more acoustic sensors 216 that are generated by at least one component of the AV. The anomaly detection module 242 filters the plurality of inputs to exclude a set of inputs identified as normal road sounds, which do not indicate a failure of the at least one component of the AV.

Method 600 includes processing the audio signals to isolate one or more sound patterns. For example, anomaly detection module 242, as illustrated in FIG. 2, may process the audio signals to isolate one or more sound patterns. This processing includes determining whether the sound patterns are associated with an anomaly indicative of a failure of at least one component of the AV. The processing further involves converting the received audio signals from a time domain to a frequency domain.

Method 600 includes processing 408 the one or more sound patterns to identify periodic sound patterns associated with tire rotation. For example, anomaly detection module 242, as illustrated in FIG. 2, may analyze the one or more sound patterns to identify periodic sound patterns associated with tire rotation. The analysis includes determining the frequency and amplitude of the periodic sound patterns to detect a specific tire of the AV exhibiting the anomaly. The analysis further involves determining whether the amplitude of the periodic sound patterns exceeds a threshold amplitude, where the threshold amplitude is established based on a comparison with initial audio signals captured during normal operation. In response to determining that the amplitude exceeds the threshold, the anomaly detection module 242 dynamically adjusts the threshold to account for environmental noise levels caused by the speed of the AV, which are unrelated to the anomaly indicative of the failure of at least one component of the AV.

Method 600 includes initiating 410 a corrective action by the AV in response to detecting a tire anomaly. For example, anomaly detection module 242, as illustrated in FIG. 2, may initiate a corrective action by the AV in response to detecting a tire anomaly. The corrective action includes one or more of reducing the vehicle's speed, directing the AV to the shoulder of a road along its route, or transmitting an alert to a vehicle operator. The determination of the anomaly is based on a calculation of the expected period of tire rotation, which incorporates the tire's circumference and the AV's speed. The expected period of tire rotation is defined as a range, including a nominal period of rotation and an error tolerance around the nominal period of rotation.

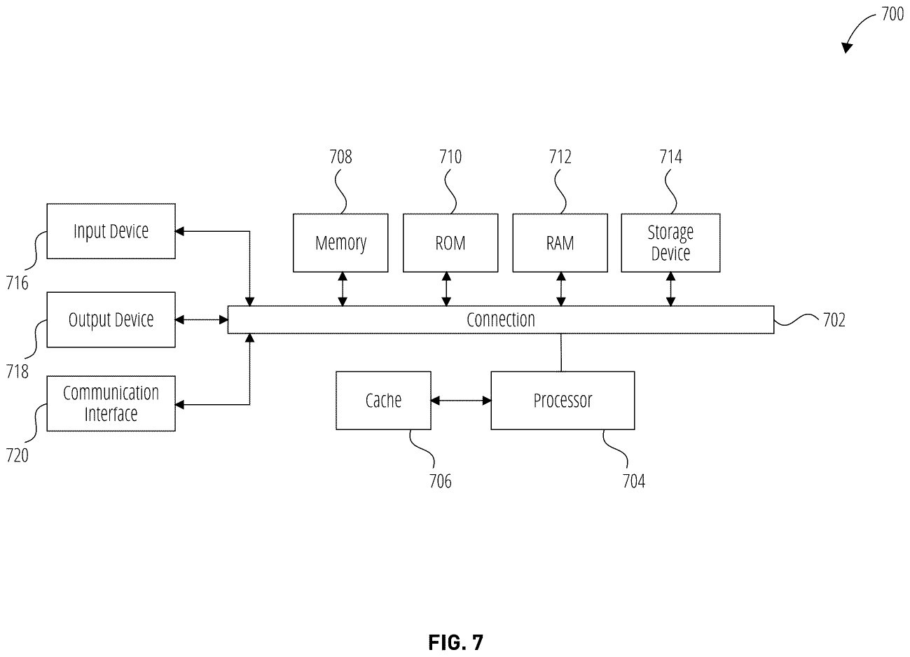

FIG. 7 illustrates an example computing system 700 that can implement various techniques, processes, functions, or methods described herein. The components of computing system 700 are shown in electrical communication with each other using a connection 702, such as a bus. The example computing system 700 includes a processing unit (or processor) 704 and a computing device connection 702 that couples various computing device components, including computing device memory 708, such as a read only memory ROM 710 and a random access memory RAM 712, to processor 704.

Computing system 700 can include a cache 706 of high-speed memory connected directly with, in close proximity to, or integrated as part of processor 704. Computing system 700 can copy data from memory 708 and/or storage device 714 to cache 706 for quick access by processor 704. In this way, cache 706 can provide a performance boost that avoids processor 704 delays while waiting for data. These and other modules can control or be configured to control processor 704 to perform various actions. Other computing device memory 708 may be available for use as well. Memory 708 can include multiple different types of memory with different performance characteristics. Processor 704 can include any general purpose processor, central processing unit (CPU), or graphics processing unit (GPU) in combination with a hardware or software provision configured to control processor 704 and stored in storage device 714, as well as any special-purpose processor where software instructions are incorporated into the processor design. Processor 704 may be a self-contained system, containing multiple cores or processors, a bus, memory controller, cache, etc. A multi-core processor may be symmetric or asymmetric.

Storage device 714 is a non-volatile memory and can be one or more of a hard disk or other types of computer readable media that can store data that are accessible by a computer, such as a magnetic cassette, flash memory card, solid state memory device, digital versatile disk, cartridge, RAM 712, ROM 710, or hybrids thereof. Memory 708 or storage device 714 can include software, code, firmware, etc., for controlling processor 704. Other hardware or software modules are contemplated. Memory 708 and storage device 714 are connected to computing device connection 702. In one aspect, a hardware module that performs a particular function can include the software component stored in a computer-readable medium in connection with the necessary hardware components, such as processor 704, computing device connection 702, and so forth, to carry out the function. In the example embodiment, processor 704 may be programmed by encoding an operation or function using one or more executable instructions and providing the executable instructions in memory 708 or storage device 714.

To enable user interaction, computing system 700 includes an input device 716, which can represent any number of input mechanisms, such as a microphone for speech, a touch-sensitive screen for gesture or graphical input, keyboard, mouse, motion input, speech, etc. Computing system 700 can also include output device 718, which can be one or more of a number of output mechanisms known to those of skill in the art. In some instances, multimodal systems can enable a user to provide multiple types of input/output to communicate with computing system 700. Computing system 700 can include communication interface 720, which can generally govern and manage the user input and system output. There is no restriction on operating on any particular hardware arrangement, and therefore the basic features here may easily be substituted for improved hardware or firmware arrangements as they are developed.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) Precise anomaly detection is achieved by positioning acoustic sensors on the tractor to monitor the trailer's tires; (b) capturing audio signals generated from each tire, allowing the system to detect irregular patterns associated with tire blowouts or other faults without requiring active feedback from the trailer; and (c) processing the audio signals to extract diagnostic data, including fault localization and severity, while generating responsive actions or alerts to ensure safe vehicle operation.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A computing system for detecting anomalies of an autonomous vehicle (AV) while navigating a route, the system comprising:
at least one memory configured to store machine executable instructions; and
at least one processor coupled to the at least one memory and configured to execute the machine executable instructions to:
receive a plurality of inputs from one or more acoustic sensors positioned in one or more locations of the AV, wherein the acoustic sensors are configured to capture audio signals associated with operation of the AV from an environment surrounding the AV;
process the plurality of inputs to identify one or more audio signals from the one or more acoustic sensors that are generated by at least one component of the AV;
in response to identifying the one or more audio signals, processing the one or more audio signals to isolate one or more sound patterns to identify whether the sound patterns are associated with an anomaly that represents a failure of the at least one component of the AV;
process the one or more sound patterns to identify periodic sound patterns associated with tire rotation, wherein the processing includes a determination of a frequency and an amplitude of the periodic sound patterns to detect a specific tire of the AV exhibiting the anomaly; and
initiate a corrective action by the AV in response to detecting a tire anomaly.

2. The system of claim 1, wherein the at least one processor is further configured to:
filter the plurality of inputs to remove a set of inputs identified as normal road sounds not indicating the failure of the at least one component of the AV.

3. The system of claim 1, wherein the corrective action comprises one or more of reducing vehicle speed, directing the AV to a shoulder of a road along a route, or transmitting an alert to a vehicle operator.

4. The system of claim 1, wherein the at least one processor is further configured to:
convert the received audio signals from a time domain to a frequency domain.

5. The system of claim 1, wherein the at least one processor is further configured to:
determine whether the amplitude of the periodic sound patterns exceeds a threshold amplitude, wherein the threshold amplitude is based on a comparison of initial audio signals captured during normal operation; and
in response to determining the amplitude exceeds the threshold, dynamically adjusting the threshold to account for environmental noise levels caused by a speed of the vehicle that are unrelated to the anomaly that represents the failure of the at least one component of the AV.

6. The system of claim 1, wherein the anomaly is determined based on a calculation of an expected period of tire rotation including a circumference of the tire and a speed of the AV, wherein the expected period of tire rotation is defined as a range including a nominal period of rotation and an error tolerance of the nominal period of rotation.

7. The system of claim 1, wherein the one or more acoustic sensors are positioned asymmetrically on an external of the AV, and the one or more processors are configured to determine a location of the anomaly by differentiating the one or more sound patterns across the one or more acoustic sensors positioned near the at least one component of the AV, wherein the location of the anomaly is associated with a failed component of the AV.

8. An autonomous vehicle (AV), comprising:
one or more tires;
at least one acoustic sensor configured to collect one or more audio signals from an environment surrounding the AV;
a memory configured to store machine executable instructions; and
at least one processor configured to execute the stored executable instructions to:
receive a plurality of inputs from one or more acoustic sensors positioned in one or more locations of the AV, wherein the acoustic sensors are configured to capture audio signals associated with operation of the AV from an environment surrounding the AV;
process the plurality of inputs to identify one or more audio signals from the one or more acoustic sensors that are generated by at least one component of the AV;
in response to identifying the one or more audio signals, processing the one or more audio signals to isolate one or more sound patterns to identify whether the sound patterns are associated with an anomaly that represents a failure of the at least one component of the AV;
process the one or more sound patterns to identify periodic sound patterns associated with tire rotation, wherein the processing includes a determination of a frequency and an amplitude of the periodic sound patterns to detect a specific tire of the AV exhibiting the anomaly; and
initiate a corrective action by the AV in response to detecting a tire anomaly.

9. The AV of claim 8, wherein the at least one processor is further configured to:
filter the plurality of inputs to remove a set of inputs identified as normal road sounds not indicating the failure of the at least one component of the AV.

10. The AV of claim 8, wherein the corrective action comprising one or more of reducing vehicle speed, directing the AV to a shoulder of a road along a route, or transmitting an alert to a vehicle operator.

11. The AV of claim 8, wherein the at least one processor is further configured to:
convert the received audio signals from a time domain to a frequency domain.

12. The AV of claim 8, wherein the at least one processor is further configured to:
determine whether the amplitude of the periodic sound patterns exceeds a threshold amplitude, wherein the threshold amplitude is based on a comparison of initial audio signals captured during normal operation; and
in response to determining the amplitude exceeds the threshold, dynamically adjust the threshold to account for environmental noise levels caused by a speed of the vehicle that are unrelated to the anomaly that represents the failure of the at least one component of the AV.

13. The AV of claim 8, wherein the anomaly is determined based on a calculation of an expected period of tire rotation including a circumference of the tire and a speed of the AV, wherein the expected period of tire rotation is defined as a range including a nominal period of rotation and an error tolerance of the nominal period of rotation.

14. The AV of claim 8, wherein the one or more acoustic sensors are positioned asymmetrically on an external of the AV, and the one or more processors are configured to determine a location of the anomaly by differentiating the one or more sound patterns across the one or more acoustic sensors positioned near the at least one component of the AV, wherein the location of the anomaly is associated with a failed component of the AV.

15. A method comprising:
receiving a plurality of inputs from one or more acoustic sensors positioned in one or more locations of an autonomous vehicle (AV), wherein the acoustic sensors are configured to capture audio signals associated with operation of the AV from an environment surrounding the AV;
processing the plurality of inputs to identify one or more audio signals from the one or more acoustic sensors that are generated by at least one component of the AV;
in response to identifying the one or more audio signals, processing the one or more audio signals to isolate one or more sound patterns; to identify whether the sound patterns are associated with an anomaly that represents a failure of the at least one component of the AV;
processing the one or more sound patterns to identify periodic sound patterns associated with tire rotation, wherein the processing includes a determination of a frequency and an amplitude of the periodic sound patterns to detect a specific tire of the AV exhibiting the anomaly; and
initiating a corrective action by the AV in response to detecting a tire anomaly.

16. The method of claim 15, further comprising:
filtering the plurality of inputs to remove a set of inputs identified as normal road sounds not indicating the failure of the at least one component of the AV.

17. The method of claim 15, wherein the corrective action comprising one or more of reducing vehicle speed, directing the AV to a shoulder of a road along a route, or transmitting an alert to a vehicle operator.

18. The method of claim 15, further comprising:
determining whether the amplitude of the periodic sound patterns exceeds a threshold amplitude, wherein the threshold amplitude is based on a comparison of initial audio signals captured during normal operation; and
in response to determining the amplitude exceeds the threshold, dynamically adjusting the threshold to account for environmental noise levels caused by a speed of the AV that are unrelated to the anomaly that represents the failure of the at least one component of the AV.

19. The method of claim 15, wherein the anomaly is determined based on a calculation of an expected period of tire rotation including a circumference of the tire and a speed of the AV, wherein the expected period of tire rotation is defined as a range including a nominal period of rotation and an error tolerance of the nominal period of rotation.

20. The method of claim 15, wherein the one or more acoustic sensors are positioned asymmetrically on an external of the AV, and one or more processors of the AV are configured to determine a location of the anomaly by differentiating the one or more sound patterns across the one or more acoustic sensors positioned near the at least one component of the AV, wherein the location of the anomaly is associated with a failed component of the AV.
